(19) United States
(12) Patent Application Publication
(10) Pub. No.: US 2011/0132774 A1
(43) Pub. Date: Jun. 9, 2011

(54) STRIP HAVING TEMPERATURE COMPENSATING FUNCTION AND METHOD OF MEASURING BLOOD GLUCOSE USING THE SAME

(76) Inventor: Jae-Hack AUM, Yongin-si (KR)

(21) Appl. No.: 12/963,267

(22) Filed: Dec. 8, 2010

(30) Foreign Application Priority Data
Dec. 9, 2009 (KR) 10-2009-0122017

(51) Int. Cl. G01N 27/416

(52) U.S. Cl. 205/782; 204/403.01

(57) ABSTRACT

Disclosed is a strip having a temperature compensating function, in which the temperature of the strip for blood collection for use in a blood glucose monitor is sensed and used as an error compensation value upon measuring blood glucose, thereby obtaining a very accurate blood glucose measurement regardless of ambient temperature and humidity and which includes first and second electrodes formed adjacent to each other to measure blood glucose, a connector inserted into a blood glucose monitor so as to be electrically connected thereto and one surface of which has upper terminals respectively connected to the first and second electrodes, a rectangular substrate including a chemically reactive member applied on or attached to the first and second electrodes, an upper cover covering an upper surface of the substrate and including a cut part to expose portions of the first and second electrodes, and a temperature sensor attached to the substrate to sense the temperature of the strip. A method of measuring blood glucose using the strip is also provided.

### BACKGROUND OF THE INVENTION

1. Field of the Invention

The present invention relates to a blood collection strip for use in a blood glucose monitor and a method of measuring blood glucose using the same, and more particularly, to a strip having a temperature compensating function, in which the temperature of the strip is sensed and used as an error compensation value upon measuring blood glucose, thereby obtaining a very accurate blood glucose measurement regardless of ambient temperature and humidity, and to a method of measuring blood glucose using the same.

2. Description of the Related Art

Blood glucose means glucose contained in the blood. The internal environments of organisms maintain homeostasis in order to stay alive, and the interactions of various hormones also balance consumption and supply of glucose by the action of the liver, thus appropriately controlling the glucose level in the blood. Blood glucose is used as an energy source of mitochondria of cells and the brain.

Also, blood glucose level is given as a concentration of glucose per 100 ml of blood, and is utilized to identify diabetes or the like.

Also, blood glucose level is typically determined by measuring the amount of glucose in the blood. However, glucose cannot be directly measured and thus is indirectly measured in such a manner that it is reacted with an enzyme and the amount of by-product produced thereby is measured, thereby determining the blood glucose level. The method of measuring blood glucose largely includes an electrochemical method for measuring current by electrons generated in the course of reacting glucose with an enzyme, and a photometric method for determining the color of a colored intermediate resulting from the enzymatic reaction.

Recently, a wide variety of blood glucose monitors are commercially available. In particular, an electrochemical type blood glucose monitor is used by inserting a strip for measuring blood glucose into the main body of the monitor and then collecting blood on the strip to measure blood glucose.

However, the strip on which the testing blood is collected is problematic because an error may occur due to the temperature of the strip upon measuring blood glucose.

Specifically, a blood glucose measurement is higher than the normal range when the temperature of the strip is high, whereas a blood glucose measurement is lower than the normal range when the temperature of the strip is low. Furthermore, opposite cases may occur depending on the type of chemically reactive material applied onto the electrodes of the strip. Specifically, a blood glucose measurement comes in low when the temperature of the strip is high, whereas a blood glucose measurement comes in high when the temperature of the strip is low.

The error may take place depending on conditions where the strip is stored, unlike the main body of the blood glucose monitor. For example, in the cold winter season, the temperature of the strip becomes lowered, whereas in the hot summer season, the strip is maintained at high temperature. Both these cases may cause problems because of errors.

### SUMMARY OF THE INVENTION

Accordingly, the present invention has been made keeping in mind the problems encountered in the related art and the present invention is intended to provide a strip having a temperature compensating function in which the temperature of the strip for blood collection for use in a blood glucose monitor is sensed, and the temperature thus sensed is used as an error compensation value upon measuring the blood glucose, thereby obtaining a very accurate blood glucose measurement regardless of ambient temperature and humidity, and also to provide a method of measuring blood glucose using the same.

An aspect of the present invention provides a strip having a temperature compensating function, comprising a first electrode and a second electrode formed adjacent to each other to measure blood glucose, a connector inserted into a blood glucose monitor so as to be electrically connected thereto and one surface of which has upper terminals respectively connected to the first electrode and the second electrode, a rectangular substrate including a chemically reactive member applied on or attached to the first electrode and the second electrode, an upper cover covering an upper surface of the substrate and including a cut part so as to expose portions of the first electrode and the second electrode of the substrate, and a temperature sensor attached to the substrate so as to sense the temperature of the strip.

Another aspect of the present invention provides a method of measuring blood glucose using a blood glucose monitor comprising a connection slot into which a connector of a strip is inserted so as to be electrically connected thereto, a current meter for detecting a current value depending on a blood glucose measurement measured by applying voltage to upper terminals of the strip connected by means of the connection slot, a temperature meter for detecting a current value depending on a temperature of the strip measured by applying voltage to lower terminals of the strip connected by means of the connection slot, a signal processor for processing an analog signal, which was input from the current meter and the temperature meter, into a digital signal so that the digital signal is input a controller, and the controller for calculating a final blood glucose level by applying an error compensation value depending on the present temperature of the strip to an initial blood glucose level using the blood glucose measurement and the temperature of the strip input from the signal processor and for storing and displaying the final blood glucose level, the method comprising detecting current flowing through a first electrode and a second electrode of the strip to which the collected blood is applied, calculating the initial blood glucose level using the detected current, detecting the temperature of the strip using a temperature sensor, compensating for an error in the initial blood glucose level using the detected temperature, calculating the final blood glucose level, and storing and displaying the calculated final blood glucose level.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a strip having a temperature compensating function according to the present invention;

FIG. 2 is a perspective view of the strip having a temperature compensating function according to the present invention;

FIG. 3 is a schematic view of the strip having a temperature compensating function according to the present invention, which is partially broken away;

FIG. 4 is a control block diagram of the strip having a temperature compensating function according to the present invention and a blood glucose monitor for use in a process of measuring blood glucose using the strip; and

FIG. 5 is a flowchart showing the process of measuring blood glucose using the strip having a temperature compensating function according to the present invention.

### DESCRIPTION OF SPECIFIC EMBODIMENTS

Hereinafter, a detailed description will be given of embodiments of the present invention with reference to the appended drawings.

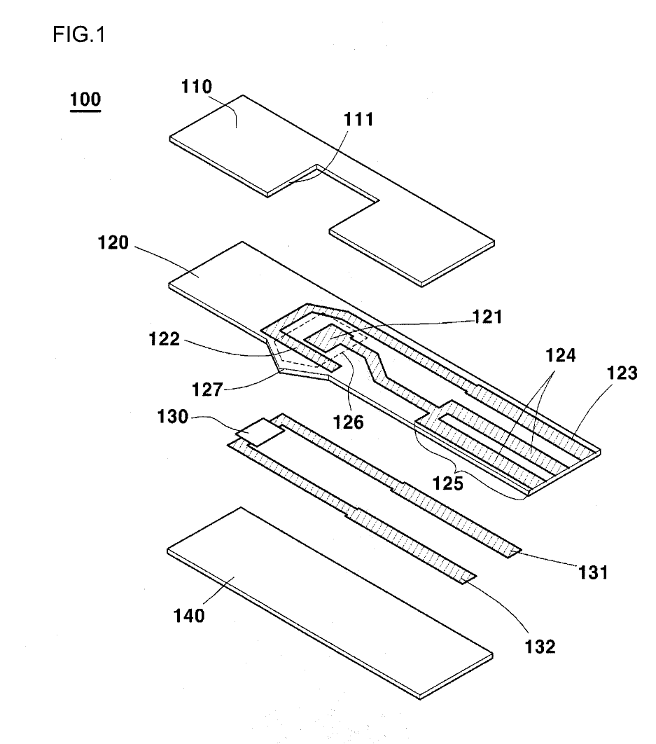

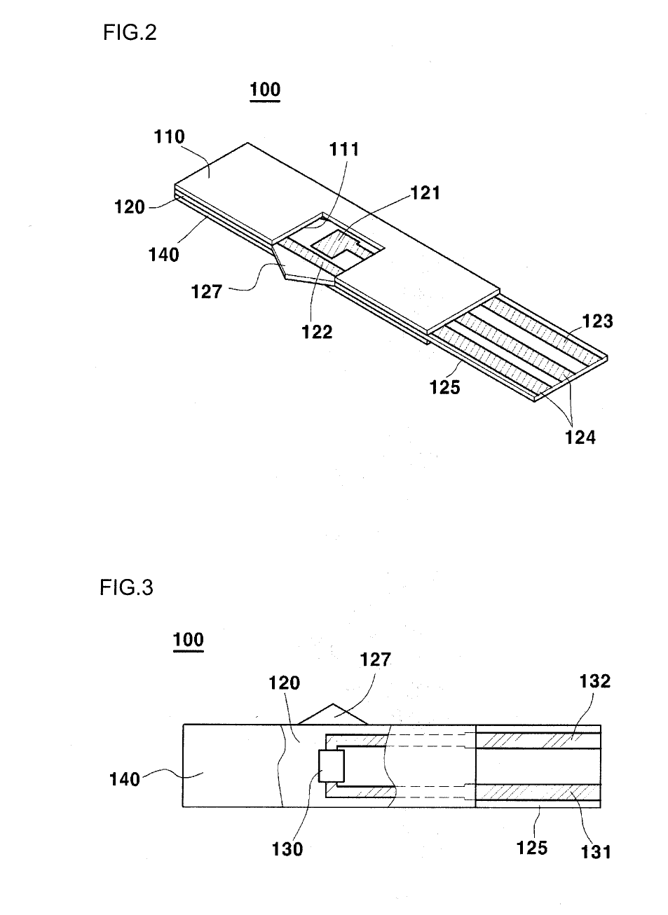

FIG. 1 is an exploded perspective view of a strip having a temperature compensating function according to the present invention, FIG. 2 is a perspective view of the strip having a temperature compensating function according to the present invention, and FIG. 3 is a schematic view of the strip having a temperature compensating function according to the present invention, which is partially broken away.

As shown in the drawings, the strip 100 having a temperature compensating function according to the present invention includes a first electrode 121 and a second electrode 122 formed adjacent to each other in order to measure blood glucose, a connector 125 inserted into a blood glucose monitor so as to be electrically connected thereto and one surface of which has upper terminals 123, 124 respectively connected to the first electrode 121 and the second electrode 122, a rectangular substrate 120 including a chemically reactive member 126 applied on or attached to the first electrode 121 and the second electrode 122, an upper cover 110 covering the upper surface of the substrate 120 and having a cut part 111 so as to expose portions of the first electrode 121 and the second electrode 122 of the substrate 120, and a temperature sensor 130 attached to the substrate 120 so as to sense the temperature of the strip 100.

In the present invention, the temperature sensor 130 functions to sense the temperature of the strip 100 so as to compensate for an error generated upon measuring blood glucose.

Specifically, the present invention is intended to solve errors in which a blood glucose measurement is high when the temperature of the strip 100 is high or in which a blood glucose measurement is low when the temperature of the strip 100 is low.

Also the above problems may occur even in the opposite cases depending on the type of chemically reactive member 126. Specifically, the errors in which a blood glucose measurement comes in low when the temperature of the strip 100 is high or in which a blood glucose measurement comes in high when the temperature of the strip 100 is low may be solved.

Such error and compensation may be set depending on the type of chemically reactive member 126.

The temperature sensor 130 may be mounted to the lower surface of the substrate 120 of the strip 100, namely, a surface opposite the surface where the first electrode 121 and the second electrode 122 are mounted, but the present invention is not limited thereto.

This sensor may be attached to the upper surface of the substrate 120, or to any appropriate place of the strip 100.

The temperature sensor 130 may further include lower terminals 131, 132 which are connected to both ends thereof and are provided on the other surface of the connector 125 inserted into the blood glucose monitor.

The temperature sensor 130 is made mainly of platinum (Pt), so that the temperature is detected from a difference in current depending on a resistance value that varies at ambient temperature.

Also, a lower cover 140 is further provided on the lower surface of the substrate 130 having the temperature sensor 130 so as to protect the exposure of the temperature sensor 130 to the outside.

Also, a guide protrusion 127 formed on one side of the substrate 120 functions as a guide upon application of the blood.

The connector 125 of the strip 100 is inserted into the blood glucose monitor 200 which will be described below so as to be electrically connected thereto, and functions to supply the current value depending on the blood glucose measurement to the blood glucose monitor 200 via the upper terminals 123, 124 and also to supply the current value depending on the measured temperature to the blood glucose monitor 200 via the lower terminals 131, 132.

In order to measure blood glucose, when a predetermined amount of blood is applied to the first electrode 121 and the second electrode 122 through the cut part 111 of the strip 100 according to the present invention, a primary chemical reaction (a glucose reaction) takes place because of the chemically reactive member 126, and thus current flowing through the first electrode 121 and the second electrode 122 changes depending on the number of electrons in proportion to the concentration of glucose in the blood.

Such current is detected, thus measuring the blood glucose level.

When measuring the blood glucose level, the temperature sensor 130 plays a role in sensing the present temperature of the strip 100 so that the sensed temperature value is used as a parameter when compensating for an error in the measured blood glucose level.

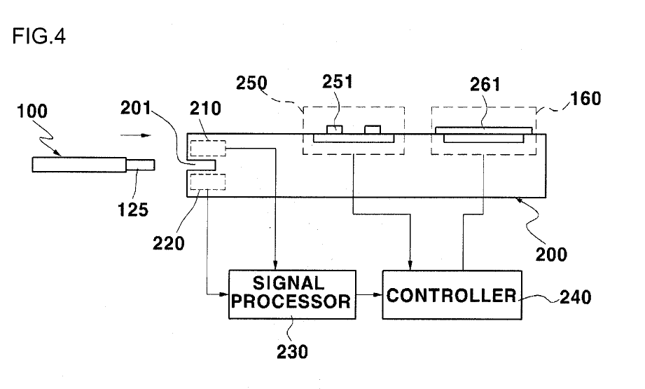

FIG. 4 is a control block diagram of the strip having a temperature compensating function according to the present invention and the blood glucose monitor for use in a process of measuring blood glucose using the strip.

As shown in the drawing, such a blood glucose monitor 200 includes a connection slot 201 into which the connector 125 of the strip 100 is inserted so as to be electrically connected thereto, a current meter 210 for detecting a current value depending on a blood glucose measurement measured by applying voltage to the upper terminals 123, 124 of the strip 100 connected by means of the connection slot 201, a temperature meter 220 for detecting a current value depending on a temperature of the strip measured by applying voltage to the lower terminals 131, 132 of the strip 100 connected by means of the connection slot 201, a signal processor 230 for processing an analog signal, which was input from the current meter 210 and the temperature meter 220, into a digital signal so that the digital signal is input to a controller 240, and the controller 240 for calculating a final blood glucose level by applying an error compensation value depending on the present temperature of the strip to an initial blood glucose level using the blood glucose measurement and the temperature of the strip input from the signal processor 230 and for storing and displaying the final blood glucose level.

Also, a key input part 250 having a plurality of functional switches 252 is further connected to the controller 240, so that commands for power supply and initiation and termination of measuring blood glucose are key input.

Also, a display part 260 having a liquid crystal display (LCD) 261 is further connected thereto, thus displaying the blood glucose level measured by the controller 240.

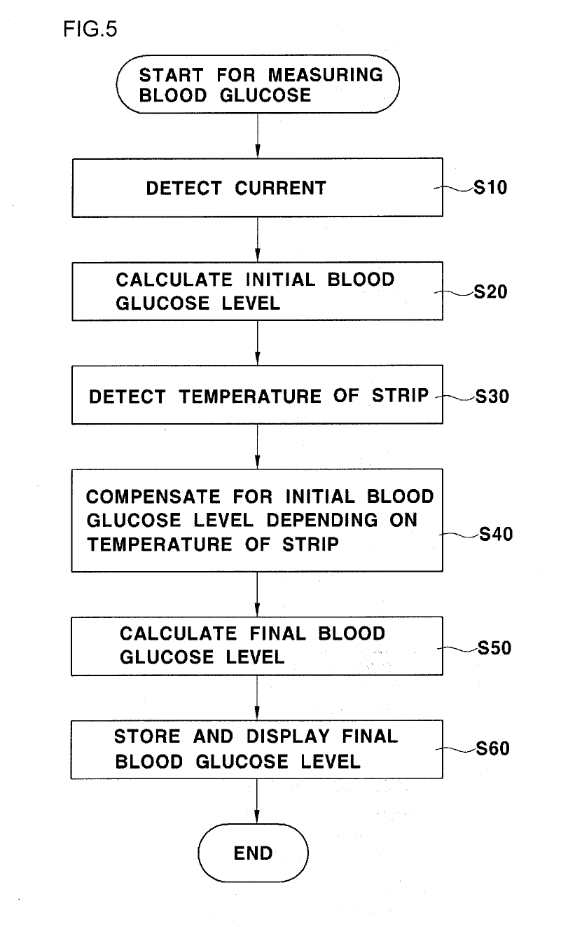

FIG. 5 is a flowchart showing a process of measuring blood glucose using the strip having a temperature compensating function according to the present invention.

As shown in the drawing, the method of measuring the blood glucose using the strip having a temperature compensating function according to the present invention includes detecting current flowing through the first electrode 121 and the second electrode 122 of the strip 100 to which the collected blood is applied (S10), calculating an initial blood glucose level using the detected current (S20), detecting the temperature of the strip 100 using the temperature sensor 130 (S30), compensating for an error in the initial blood glucose level using the detected temperature (S40), calculating a final blood glucose level (S50), and storing and displaying the calculated final blood glucose level (S60).

At S40, compensating for the error in the initial blood glucose level using the detected temperature of the strip 100 may include adding or subtracting a value of the initial blood glucose level depending on the detected temperature. Specifically, when the temperature of the strip 100 is high, the initial blood glucose level is adjusted to decrease, whereas the initial blood glucose level is adjusted to increase when the temperature of the strip 100 is low.

The overall operation according to the present invention is specified.

A user inserts the connector 125 of the strip 100 into the connection slot 201 of the blood glucose monitor 200, operates the key input part 260 so that power is supplied and measuring blood glucose is initiated.

Then, the blood is collected and applied to the first electrode 121 and the second electrode 122 through the cut part 111 of the strip 100.

As such, the first and second electrodes 121, 122 are electrically connected to each other, and thus current flows therethrough. This current value is detected by the current meter 210 and is input to the controller 240 via the signal processor 230 (S10).

The controller 240 calculates the initial blood glucose level using the current value, resulting from electrically connecting the first and second electrodes 121, 122 to each other, input from the signal processor 230 (S20).

Simultaneously, the current value flowing through the temperature sensor 130 of the strip 100 is detected by means of the temperature meter 220 and then input to the controller 240 via the signal processor 230. As such, the controller 240 is aware of the present temperature of the strip 100 because of the input value (S30).

The controller 240 compensates for the error in the initial blood glucose level using the temperature value of the strip and calculates the final blood glucose level (S40, S50).

The controller 240 stores the final blood glucose level and displays it on the LCD 261 of the display part 260.

Therefore, the user can recognize his or her accurate blood glucose level on the LCD 261 of the blood glucose monitor 200.

As described hereinbefore, the present invention provides a strip having a temperature compensating function and a method of measuring blood glucose using the same. According to the present invention, the temperature of the strip for blood collection can be sensed and used as an error compensation value upon measuring the blood glucose, thereby obtaining a very accurate blood glucose measurement regardless of ambient temperature and humidity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A strip having a temperature compensating function, comprising:
a first electrode and a second electrode foamed adjacent to each other to measure blood glucose;
a connector inserted into a blood glucose monitor so as to be electrically connected thereto and one surface of which has upper terminals respectively connected to the first electrode and the second electrode;
a rectangular substrate including a chemically reactive member applied on or attached to the first electrode and the second electrode;
an upper cover covering an upper surface of the substrate and including a cut part so as to expose portions of the first electrode and the second electrode of the substrate; and
a temperature sensor attached to the substrate so as to sense a temperature of the strip.

2. The strip as set forth in claim 1, wherein the temperature sensor is mounted to a lower surface of the substrate of the strip, and further includes lower terminals connected to both ends thereof and provided on the other surface of the connector inserted into the blood glucose monitor.

3. The strip as set forth in claim 1, further comprising a lower cover on the lower surface of the substrate having the temperature sensor.

4. A method of measuring blood glucose using a blood glucose monitor comprising a connection slot into which a connector of a strip is inserted so as to be electrically connected thereto, a current meter for detecting a current value depending on a blood glucose measurement measured by applying voltage to upper terminals of the strip connected by means of the connection slot, a temperature meter for detecting a current value depending on a temperature of the strip measured by applying voltage to lower terminals of the strip connected by means of the connection slot, a signal processor for processing an analog signal, which was input from the current meter and the temperature meter, into a digital signal so that the digital signal is input to a controller, and the controller for calculating a final blood glucose level by applying an error compensation value depending on the present temperature of the strip to an initial blood glucose level using the blood glucose measurement and the temperature of the strip input from the signal processor and for storing and displaying the final blood glucose level, the method comprising:
detecting current flowing through a first electrode and a second electrode of the strip to which collected blood is applied;
calculating the initial blood glucose level using the detected current;
detecting the temperature of the strip using a temperature sensor;
compensating for an error in the initial blood glucose level using the detected temperature;
calculating the final blood glucose level; and
storing and displaying the calculated final blood glucose level.

5. The method as set forth in claim 4, wherein the compensating for the error in the initial blood glucose level is performed by adding or subtracting a value of the initial blood glucose level depending on the detected temperature.
